(19) United States
(12) Patent Application Publication
(10) Pub. No.: US 2025/0216617 A1
(43) Pub. Date: Jul. 3, 2025

(54) OPTICAL FIBER CONNECTOR STRUCTURALLY CONFIGURED TO MITIGATE AGAINST TEMPERATURE FLUCTUANCE SIGNAL DEGRADATION

(71) Applicant: PPC BROADBAND, INC., East Syracuse, NY (US)

(72) Inventor: Raymond PALINKAS, Canastota, NY (US)

(73) Assignee: PPC BROADBAND, INC., East Syracuse, NY (US)

(21) Appl. No.: 19/002,906

(22) Filed: Dec. 27, 2024

Related U.S. Application Data
(60) Provisional application No. 63/616,298, filed on Dec. 29, 2023.

(51) Int. Cl. G02B 6/38

(52) U.S. Cl. CPC G02B 6/3821; G02B 6/3838; G02B 6/3843; G02B 6/3858; G02B 6/3897

(57) ABSTRACT

A fiber optic connector that may be configured to mitigate against signal degradation when the connector is exposed to significant temperature fluctuations. The connector may include a fiber coupler that optically couples an optical fiber and a fiber portion. The fiber coupler may include a fiber guide, and a biasing member that may be configured to bias the fiber guide axially in at least a portion of the fiber coupler between a first position and a second position. The fiber guide may be configured to align respective ends of the optical fiber and the fiber portion. The fiber guide may configured to be released to permit the biasing member to move the fiber guide from the first position to the second position such that the end of the optical fiber may be biasingly urged to contact with the end of the fiber portion so as to biasingly maintain optical coupling between the optical fiber and the fiber portion and mitigate against signal loss by biasingly urging against movement of the end of the optical fiber relative to the end of the fiber portion during operation of the connection and when the connector is exposed to significant temperature fluctuations.

### CROSS-REFERENCE TO RELATED APPLICATION

This application claims the benefit of U.S. Provisional Patent Application No. 63/616,298, filed on Dec. 29, 2023, the disclosure of which is hereby incorporated by reference herein in its entirety.

### BACKGROUND

The present invention relates generally to optical fiber connectors. More particularly, the present invention relates to optic fiber connectors that are configured to mitigate against temperature fluctuation signal degradation.

The use of fiber optic mechanical connectors is increasing. Initially, this increase was seen in connections inside structures where such connections are protected from being exposed to significant temperature fluctuations since performance can degrade dramatically when exposed to such significant temperature fluctuations. Operators are looking for a low cost, field installable connector that maintains performance in exterior environments where such connections are not protected from being exposed to such temperature changes.

Although embodiments of the disclosure will be discussed using optical fiber cables as an example, embodiments of the disclosure can be applied to other types of cables.

It may be desirable to provide a connector that is configured to mitigate against signal degradation that can result from temperature fluctuations. In embodiments, a retaining portion may be structurally configured to be released to permit a fiber guide portion biasing portion to move a fiber guide portion from a first position to a second position such that an end portion of an optical fiber is urged into contact with an end portion of a fiber portion so as to maintain optical coupling between the optical fiber and the fiber portion and mitigate signal loss due to movement of the end portion of the optical fiber relative to the end portion of the fiber portion.

### SUMMARY

Some installations require a connector to be installed on a fiber optic cable in the field. A cause of performance degradation when a connector is exposed to significant temperature fluctuations is a small amount of separation where the optical fiber mates to the ferrule. Another issue that can arise in a fixed mating design is failure during installation of the fiber to the connector. The installer must maintain a positive tension forward until the fiber is clamped in place by the connector seizure mechanism. Embodiments of the disclosure provide an internal feature to a connector that applies a level of positive force from the optical fiber to the ferrule mating surface. This can be achieved by several methods using resilient materials like springs, rubbers, and the optical fiber itself.

Particular embodiments provide a fiber optic connector structurally configured to mitigate against signal degradation when the connector is exposed to significant temperature fluctuations, including: an outer housing portion; an inner housing portion structurally configured to be coupled with the outer housing portion; and a fiber coupling portion having a first end and a second end and being structurally configured to optically couple an optical fiber and a fiber portion therein. The fiber coupling portion may include: a fiber guide portion that may be structurally configured to guide the optical fiber; a fiber guide housing portion that may be structurally configured to slidingly receive the fiber guide portion therein; a fiber securing portion that may be structurally configured to fixedly couple the fiber guide portion to the optical fiber; and a fiber guide portion biasing portion that may be structurally configured to bias the fiber guide portion toward the first end of the fiber coupling portion. The fiber guide portion may be structurally configured to move axially within the fiber coupling portion between a first position and a second position; the fiber coupling portion may be structurally configured to move axially within the inner housing portion; the fiber guide portion biasing portion may be structurally configured to bias the fiber guide portion from the first position to the second position; the fiber guide portion may comprise a fiber guide receiving portion; the fiber guide receiving portion may be structurally configured to receive the optical fiber; the fiber guide receiving portion may be structurally configured to align an end portion of the optical fiber with an end portion of the fiber portion; the fiber coupling portion may include a retaining portion that may be structurally configured to secure the fiber guide portion in the first position against a force of the fiber guide portion biasing portion; and the retaining portion may be structurally configured to be released to permit the fiber guide portion biasing portion to move the fiber guide portion from the first position to the second position such that the end portion of the optical fiber is urged into contact with the end portion of the fiber portion so as to maintain optical coupling between the optical fiber and the fiber portion and mitigate against signal loss by biasingly urging against movement of the end portion of the optical fiber relative to the end portion of the fiber portion when the connector is exposed to temperature fluctuations between-40 degrees C. and 60 degrees C.

According to various embodiments, the fiber guide portion may comprise a clamping portion that may be structurally configured to bias the fiber securing portion to fixedly couple the fiber guide portion to the optical fiber.

According to various embodiments, the clamping portion may be structurally configured as a c-shaped resilient clip.

According to various embodiments, the outer housing portion may be an outer housing of an SC connector.

According to various embodiments, the fiber optic connector further comprises a cable receiving portion that may be structurally configured to receive a portion of a fiber optic cable containing the optical fiber.

According to various embodiments, the fiber optic connector further comprises a boot portion that may be structurally configured to engage the cable receiving portion.

According to various embodiments, the boot portion may be structurally configured to form a seal with the fiber optic cable.

Particular embodiments provide a fiber optic connector structurally configured to mitigate against signal degradation when the connector is exposed to temperature fluctuations, including: a housing portion; and a fiber coupling portion having a first end and a second end and being structurally configured to optically couple an optical fiber and a fiber portion therein. The fiber coupling portion may include: a fiber guide portion that may be structurally configured to guide the optical fiber; a fiber guide housing portion that may be structurally configured to slidingly receive the fiber guide portion therein; and a fiber guide portion biasing portion that may be structurally configured to bias the fiber guide portion toward the first end of the fiber coupling portion. The fiber guide portion may be structurally configured to move axially in at least a portion of the fiber coupling portion between a first position and a second position; the fiber coupling portion may be structurally configured to move axially within the housing portion; the fiber guide portion biasing portion may be structurally configured to bias the fiber guide portion from the first position to the second position; the fiber guide portion may comprise a fiber guide receiving portion; the fiber guide receiving portion may be structurally configured to receive the optical fiber; the fiber guide receiving portion may be structurally configured to align an end portion of the optical fiber with an end portion of the fiber portion; and the fiber guide portion may be structurally configured to be released to permit the fiber guide portion biasing portion to move the fiber guide portion from the first position to the second position such that the end portion of the optical fiber is urged into contact with the end portion of the fiber portion so as to maintain optical coupling between the optical fiber and the fiber portion and mitigate against signal loss by biasingly urging against movement of the end portion of the optical fiber relative to the end portion of the fiber portion when the connector is exposed to temperature fluctuations between −40 degrees C. and 60 degrees C.

According to various embodiments, the housing portion comprises an outer housing portion and an inner housing portion that may be structurally configured to be coupled with the outer housing portion.

According to various embodiments, the fiber coupling portion includes a retaining portion that may be structurally configured to secure the fiber guide portion in the first position against a force of the fiber guide portion biasing portion.

According to various embodiments, the fiber optic connector further comprises a cable receiving portion that may be structurally configured to receive a portion of a fiber optic cable containing the optical fiber.

According to various embodiments, the fiber coupling portion further comprises a fiber securing portion that may be structurally configured to fixedly couple the fiber guide portion to the optical fiber.

According to various embodiments, the fiber guide portion comprises a clamping portion that may be structurally configured to bias the fiber securing portion to fixedly couple the fiber guide portion to the optical fiber.

According to various embodiments, the clamping portion may be a c-shaped resilient clip.

Particular embodiments provide a fiber optic connector structurally configured to mitigate against signal degradation even when the connector is exposed to significant temperature fluctuations, including: a fiber coupling portion configured to optically couple an optical fiber and a fiber portion therein. The fiber coupling portion may include: a fiber guide portion that may be configured to guide the optical fiber; a fiber guide housing portion that may be configured to slidingly receive the fiber guide portion therein; and a fiber guide portion biasing portion that may be configured to bias the fiber guide portion axially in at least a portion of the fiber coupling portion between a first position and a second position. The fiber guide portion may be configured to align an end portion of the optical fiber with an end portion of the fiber portion; and the fiber guide portion may be configured to permit the fiber guide portion biasing portion to bias the fiber guide portion from the first position toward the second position such that the end portion of the optical fiber is biasingly urged into contact with the end portion of the fiber portion so as to biasingly maintain optical coupling between the optical fiber and the fiber portion and mitigate against signal loss by biasingly preventing movement of the end portion of the optical fiber relative to the end portion of the fiber portion when the connector is exposed to temperature fluctuations between −40 degrees C. and 60 degrees C.

According to various embodiments, the cable connector further comprises a housing portion, and the fiber coupling portion may be configured to move axially in at least a portion of the housing portion.

According to various embodiments, the fiber guide portion biasing portion may be configured to bias the fiber guide portion toward an end of the fiber coupling portion.

According to various embodiments, the fiber guide portion biasing portion may be configured to bias the fiber guide portion from the first position to the second position.

According to various embodiments, the fiber guide portion comprises a fiber guide receiving portion, and the fiber guide receiving portion may be configured to receive the optical fiber.

According to various embodiments, the fiber coupling portion includes a retaining portion that may be configured to secure the fiber guide portion in the first position against a force of the fiber guide portion biasing portion.

According to various embodiments, the fiber coupling portion further comprises a fiber securing portion that may be configured to fixedly couple the fiber guide portion to the optical fiber.

According to various embodiments, the fiber guide portion comprises a clamping portion that may be configured to bias the fiber securing portion to fixedly couple the fiber guide portion to the optical fiber.

According to various embodiments, the clamping portion may be a c-shaped resilient clip.

Various aspects of the connector, as well as other embodiments, objects, features and advantages of this disclosure, will be apparent from the following detailed description of illustrative embodiments thereof, which is to be read in conjunction with the accompanying drawings.

### BRIEF DESCRIPTION OF THE DRAWINGS

FIG. 1 is a perspective sectional view of an exemplary connector in accordance with embodiments of the disclosure with a biasing member in a less compressed state.

FIG. 2 is a perspective sectional view of the connector of FIG. 1 with the biasing member in a more compressed state.

FIG. 3 is a partial perspective sectional view of the connector of FIG. 1 in a less compressed state.

FIG. 4 is a partial perspective sectional view of the connector of FIG. 1 in a more compressed state.

FIG. 5 is a partial perspective sectional view of the connector of FIG. 1 in a less compressed state.

FIG. 6 is a partial perspective sectional view of the connector of FIG. 1 in a more compressed state.

FIG. 7 is a perspective sectional view of the connector of FIG. 1 along line A- A in FIG. 8.

FIG. 8 is a perspective view of the connector of FIG. 1.

FIG. 9 is a perspective view of the connector of FIG. 1.

FIG. 10 is a perspective view of the connector of FIG. 1.

FIG. 11 is an end view of the connector of FIG. 1.

FIG. 12 is an end view of the connector of FIG. 1.

FIG. 13 is an exploded view of the connector of FIG. 1.

FIG. 14 is a partial exploded view of the connector of FIG. 1.

FIG. 15 is a partial exploded view of the connector of FIG. 1.

FIG. 16 is a partial exploded view of the connector of FIG. 1.

### DETAILED DESCRIPTION OF EMBODIMENTS

Embodiments of the disclosure provide a retaining portion structurally configured to be released to permit a fiber guide portion biasing portion to move a fiber guide portion from a first position to a second position such that an end portion of an optical fiber is urged into contact with an end portion of a fiber portion so as to maintain optical coupling between the optical fiber and the fiber portion and mitigate signal loss by biasingly urging against movement of the end portion of the optical fiber relative to the end portion of the fiber portion

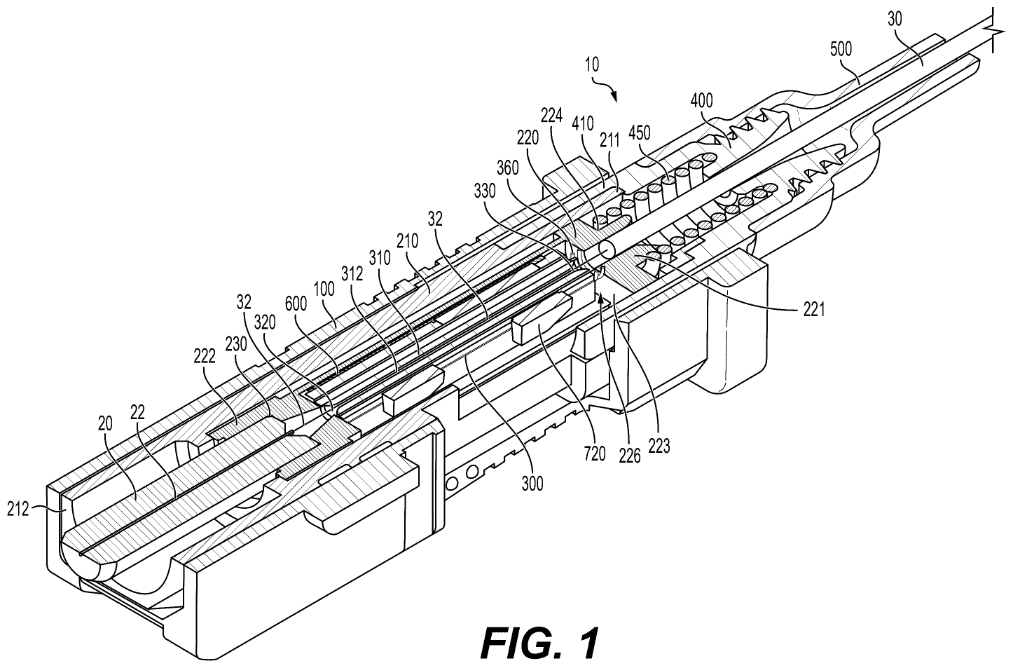

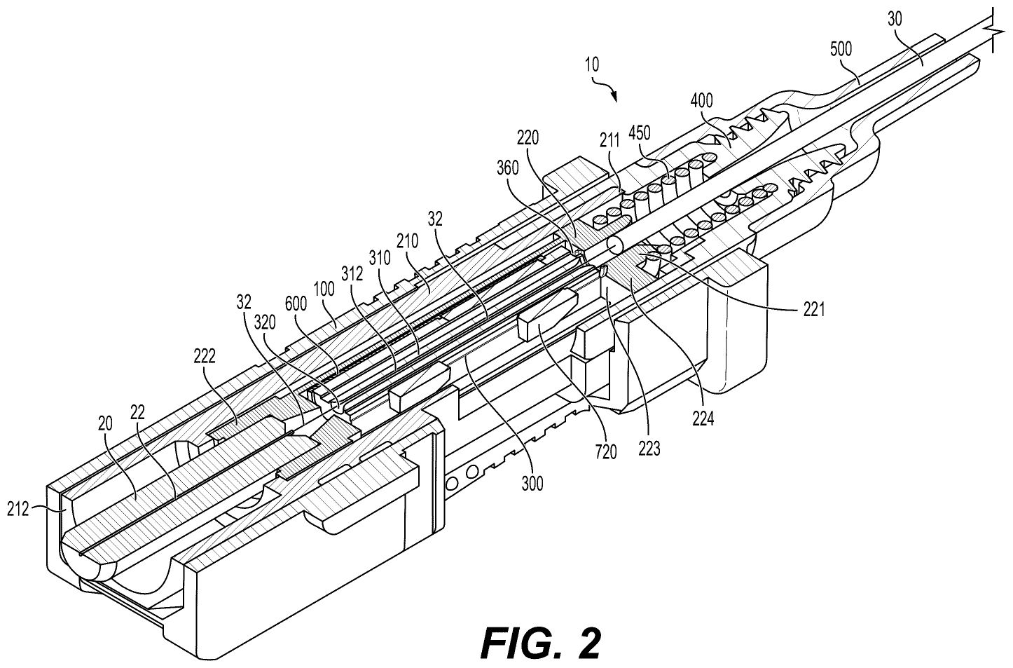

FIGS. 1 and 2 show an exemplary connector 10 in accordance with embodiments of the disclosure. Connector 10 joins two optical fibers such that a signal transmitted by one of the two optical fibers is properly and securely transmitted to the other of the two optical fibers. In this example, connector 10 has an outer housing portion, for example, an outer housing, 100 that receives a ferrule 20 including a fiber portion 22 at one end of the connector 10. An optical fiber cable 30 including an optical fiber 32 is received at the other end of the connector 10.

In this example, outer housing 100 surrounds an inner housing portion, for example, an inner housing, 210 that, in turn supports a fiber coupling portion, for example, a cradle, 220. Inner body 210 has a second end 212 that is configured to receive a ferrule 20 that terminates the fiber portion, or fiber stub, 22. Cradle 220 has a ferrule holding portion 230 at a second end of cradle 220 that is configured to hold the ferrule 20. Inner housing 210 is configured at a first end 211 to be received by a cable receiving portion, for example, a cable receiving body 400. Cable receiving body 400, in this example, has an inner housing receiving portion 410 that is configured to receive the first end 211 of inner housing 210. A boot portion, for example, a boot, 500, in some embodiments made of a resilient material, is configured to engage cable receiving body 400 to create a waterproof seal around fiber optic cable 30 that enters connector 10.

Cradle 220 is configured to receive a fiber guide holding portion, for example, a fiber guide holder, 300 in a fiber guide holder receiving area 226 such that fiber guide holder 300 can move longitudinally within fiber guide holder receiving area 226. FIG. 1 shows fiber guide holder 300 in a second position, which is toward a second end 222 of cradle 220, whereas FIG. 2 shows fiber guide holder 300 in a first position, which is toward a first end 221 of cradle 220. A fiber guide holder biasing portion, for example, a fiber guide holder biasing member, for example, a fiber guide holder spring, 360 is positioned between cradle 220 and fiber guide holder 300 and urges fiber guide holder 300 toward the second end 222 of cradle 220 (to the left in FIGS. 1 and 2). Fiber guide holder 300 is configured to receive a fiber guide portion, for example, a fiber guide, 310 having a fiber receiving portion, for example, a fiber channel, 312. Fiber channel 312 is configured to support optical fiber 32 being connected to fiber portion 22 by connector 10. In embodiments, fiber guide holder 300, and/or fiber guide 310 are configured as two pieces, one or both of which being configured to hold an end of one of the optical fibers, in this example, optical fiber 32. In embodiments, fiber channel 310 is sized for a specific diameter optical fiber such that the end of the optical fiber is supported radially so as to restrict radial movement of the optical fiber. This restriction keeps the ends of the two optical fibers aligned to promote optimal signal transfer. In embodiments, fiber guide holder biasing member 360 can be a resilient material such as, for example, rubber. In embodiments, cable receiving body 400 and/or cradle 220 grips optical fiber cable 30 to resist damage to optical fiber 32 that could result from force being applied to optical fiber cable 30 from outside of the connector 10.

In embodiments, the fiber channel 312 is configured to receive both the end of fiber portion 22 and the end of optical fiber 32 such that the contact point of the end of fiber portion 22 and the end of optical fiber 32 is supported by fiber channel 312 to resist lateral movement of either the end of fiber portion 22 or the end of optical fiber 32. In embodiments, the optical fiber 32 will be encased in a coating for at least a portion of its length in fiber channel 312.

In this example, fiber guide 310 has a second flared portion 320 at a second end of fiber guide 310, and a first flared portion 330 at a first end of fiber guide 310. Flared portion 330 aids in guiding the end of optical fiber 32 into fiber guide 310.

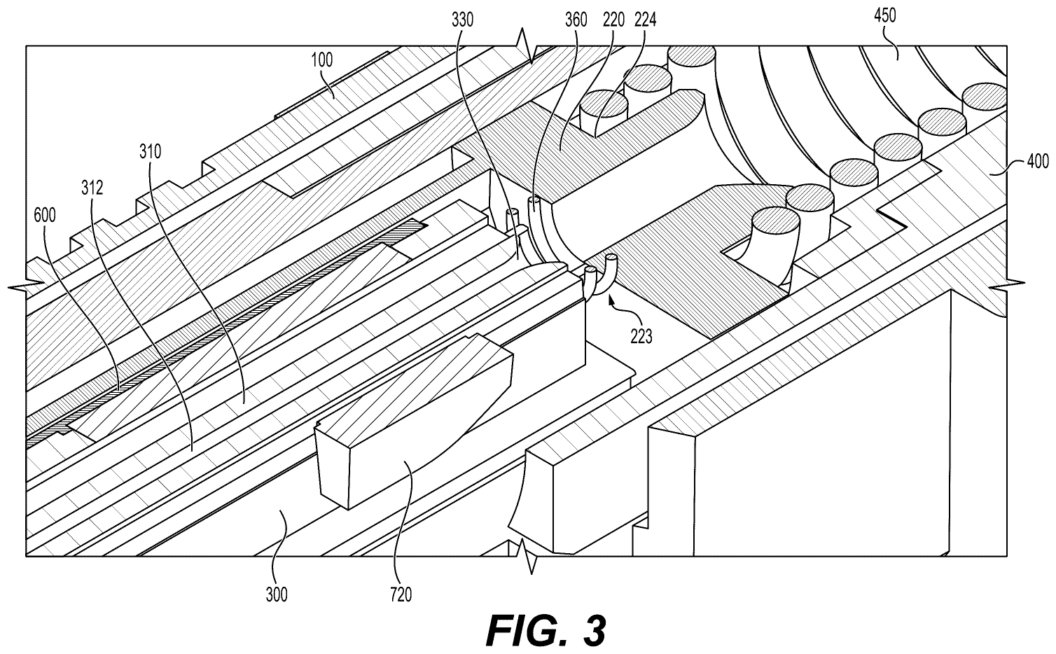

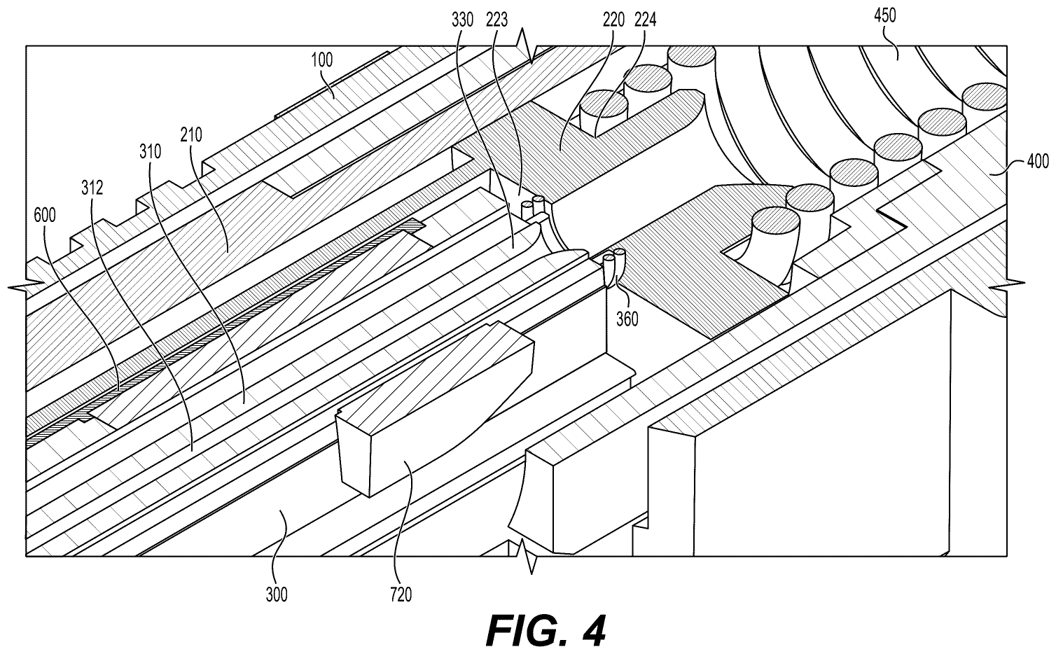

FIGS. 3 and 4 are magnified views of portions of FIGS. 1 and 2, respectively. FIG. 3 shows fiber guide holder spring 360 in the second position (a less compressed state) and FIG. 4 show fiber guide holder spring 360 in the first position (a more compressed state). As shown in FIGS. 3 and 4, fiber guide holder spring 360 bears on a spring bearing portion 223 of cradle 220 to urge fiber guide holder 300 to the left in the Figures. As shown in FIGS. 3 and 4, a cradle biasing portion, for example, a cradle biasing member, for example, a cradle spring, 450 bears on a spring bearing portion 224 of cradle 220 to urge cradle 220 to the left in the Figures. In embodiments, cradle biasing member 450 can be a resilient material such as, for example, rubber.

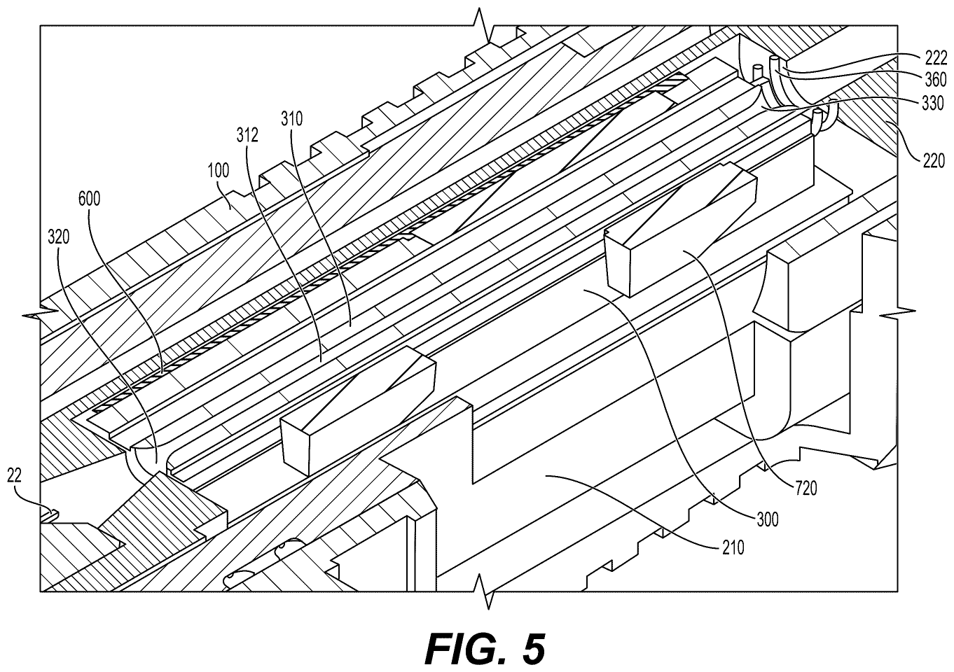

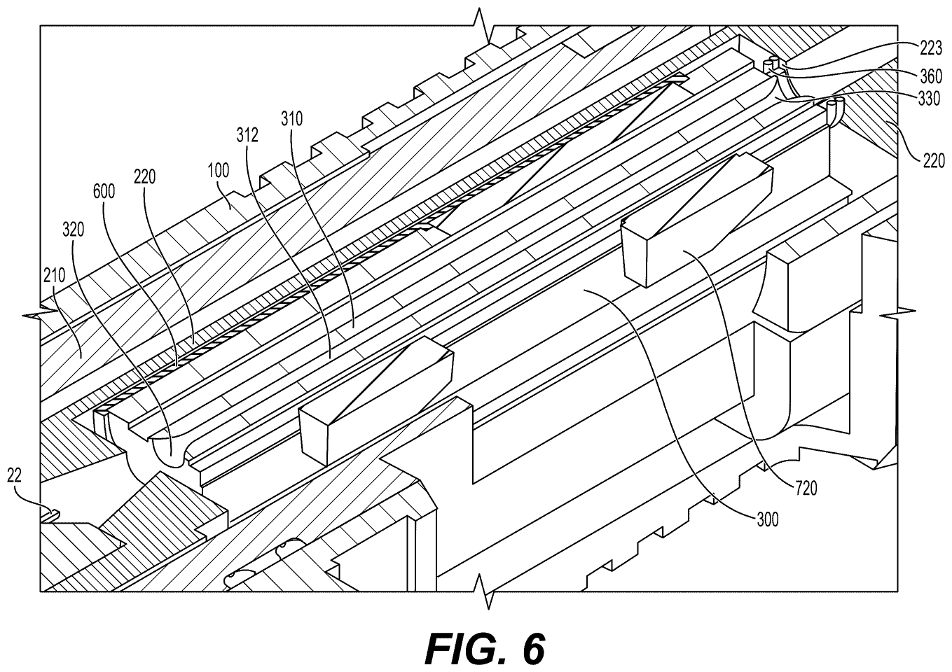

FIGS. 5 and 6 show magnified views of fiber guide holder 300 and fiber guide 310. FIG. 5 shows fiber guide holder 300 in the second position urged to the left such that fiber guide holder 300 contacts cradle 220 at its first end (the end opposite fiber guide holder spring 360). FIG. 6 shows fiber guide holder 300 in the first position, to the right, compressing fiber guide holder spring 360. Fiber guide holder 300 is held in the first position (FIGS. 2, 4, 6) by a retaining portion, for example, a catch mechanism, 720 that holds fiber guide holder 300 in the first position against the force of fiber guide holder spring 360. The end of optical fiber 32 is inserted into fiber channel 312 while fiber guide holder 300 (and thus fiber guide 310) is in the first position shown in FIGS. 2, 4, 6 and extends from fiber channel 312 to the point where the ends of the optical fibers 22, 32 touch each other.

After the end of optical fiber 32 is inserted into fiber channel 312, a clamping portion 700 is positioned over fiber guide holder 300 to secure optical fiber 32 in fiber guide holder 300. A fiber securing portion 600 is then positioned at least partially around clamping portion 700 and fiber guide holder 300 to secure clamping potion 700 to fiber guide holder 300. The catch mechanism 720 is then released so that fiber guide holder spring 360 can push fiber guide holder 300 to the second position (to the left in the Figures). The force of fiber guide holder spring 360 keeps the ends of fiber portion 22 and optical fiber 32 in contact with each other even if various parts of connector 10 expand, contract, or otherwise move when the connector is exposed to significant temperature fluctuations.

In optical fiber connectors, a return loss of at least 50 dB is desirable. At room temperature, some straight-through connectors in which the optical fiber is not interrupted in the connector itself have about 70 dB of return loss, where as some mechanical connectors (in which the optical fiber is interrupted in the connector) have about 50 dB of return loss. As a result, temperatures below room temperature can push the return loss below the desirable minimum of 50 dB. The industry standard operating temperature range for connectors is −40 degrees C. to 60 degrees C. At the low end of the industry standard temperature range (around −40 degrees C.), the return loss in mechanical connectors can drop down as low as 20-30 dB (which is not desirable). Embodiments of the disclosure provide a solution to this problem by exerting the above-described biasing on the contact point of the end of the fiber portion 22 and the end of the optical fiber 32.

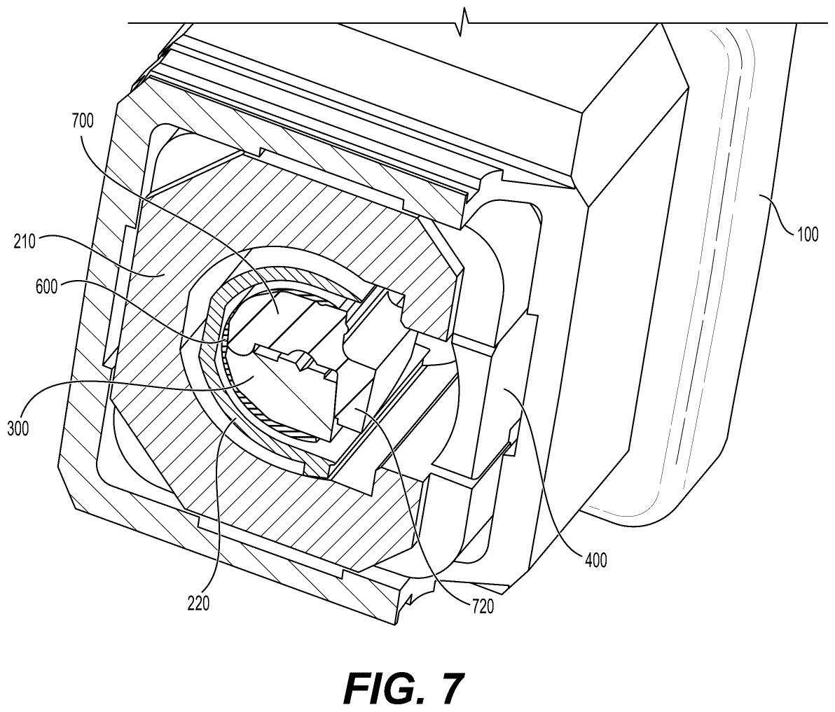

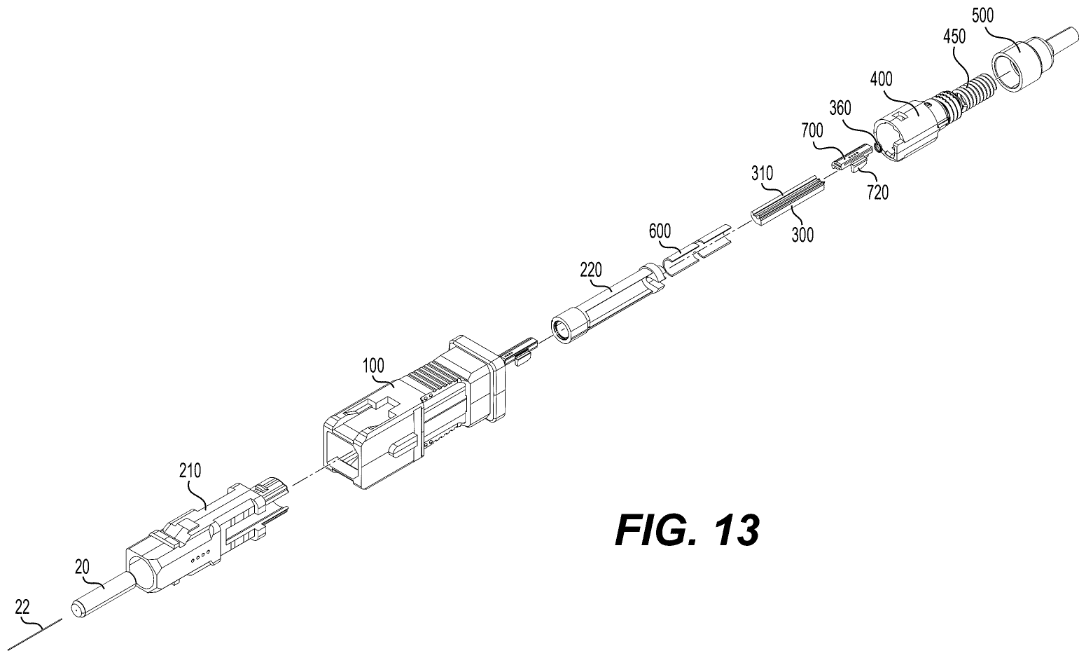

FIG. 7 is a cross-sectional view of connector 10 and shows fiber securing portion 600 that is configured to fixedly couple the fiber guide housing portion to optical fiber 32. In this example, fiber securing portion 600 is a resilient “C” shaped member (see FIG. 13) that clamps clamping portion 700 to fiber guide holder 300 to secure optical fiber 32 in fiber guide holder 300. The clamping force provided by fiber securing portion 600 pinches optical fiber 32 between clamping portion 700 and fiber guide holder 300 such that optical fiber 32 moves with fiber guide holder 300, including when fiber guide holder spring 360 biases fiber guide holder 300 to the second position shown in FIG. 1.

As shown in FIGS. 1 and 2, cradle biasing member, for example, cradle spring, 450 is positioned between cable receiving body 400 and cradle 220 and urges cradle 220 toward the first end of inner body 210 (to the left in FIGS. 1 and 2).

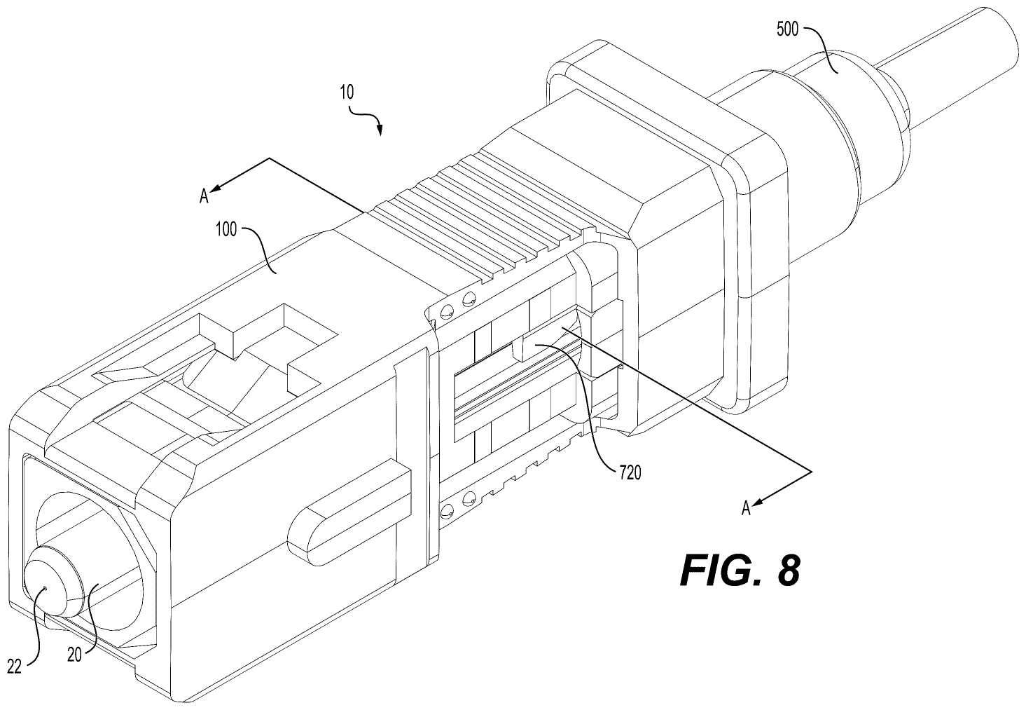

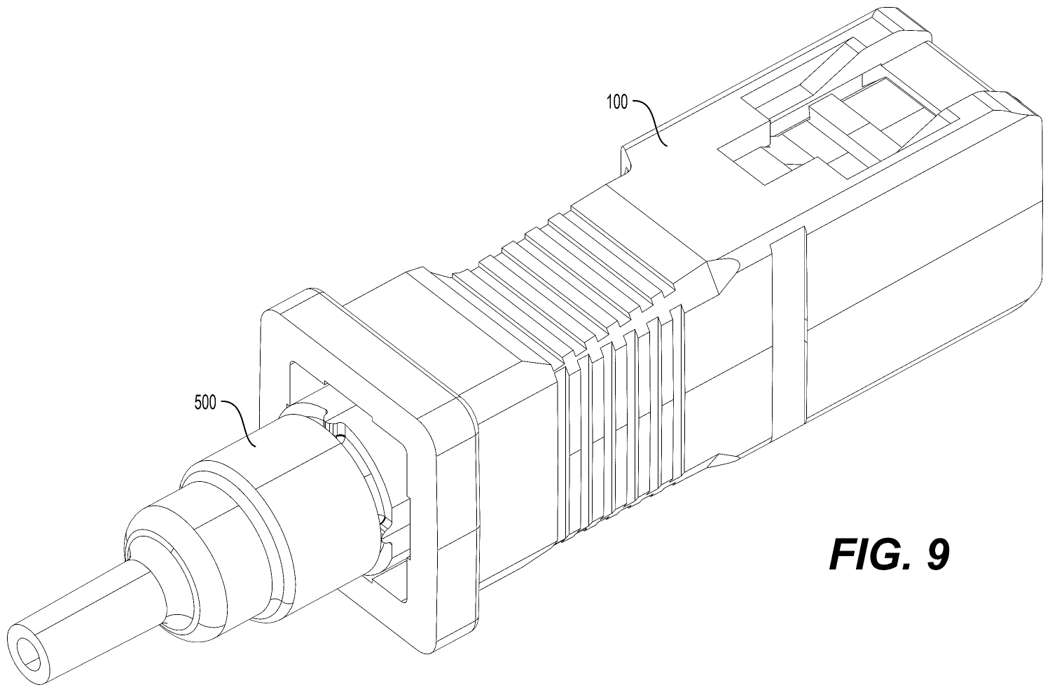

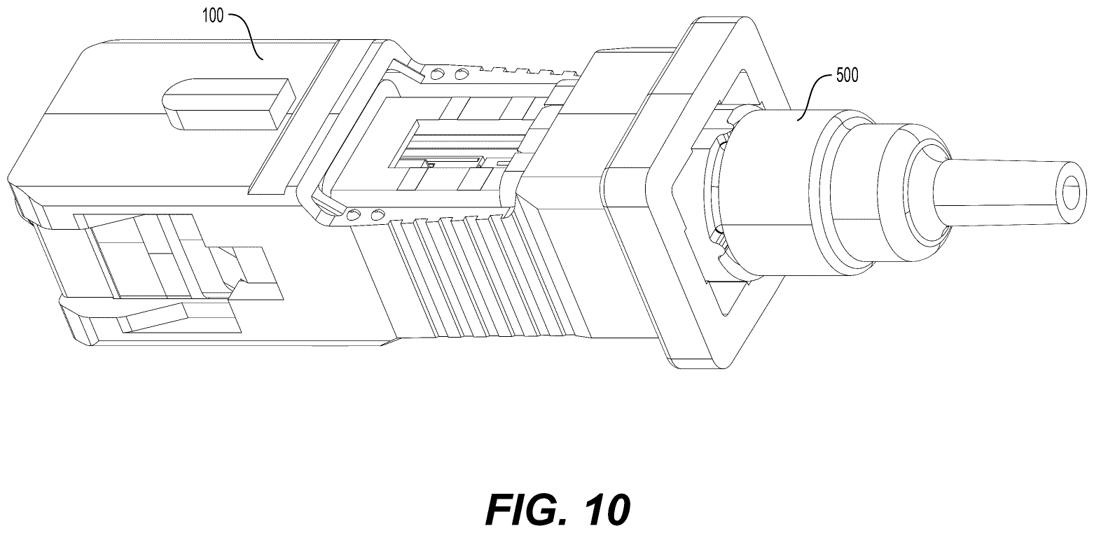

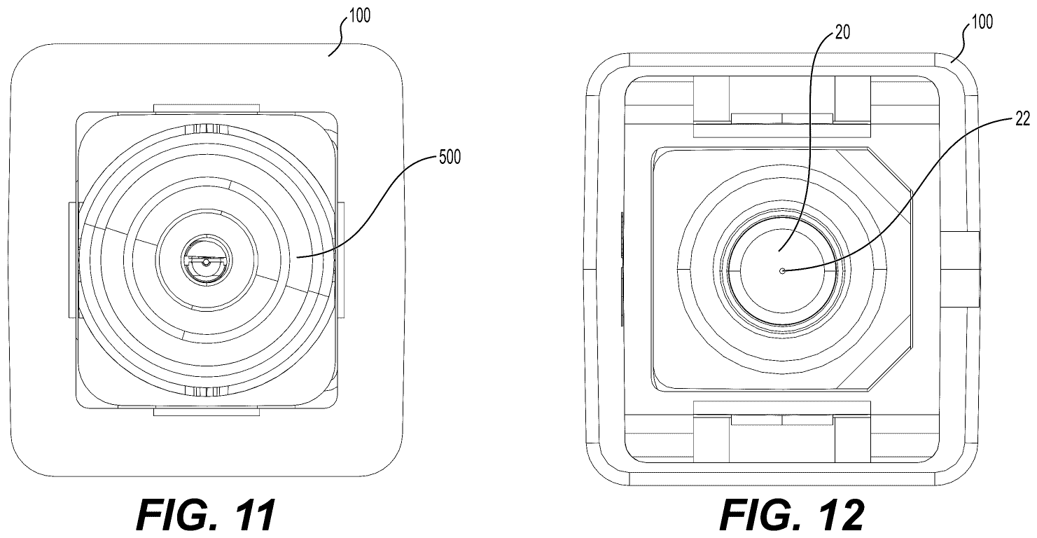

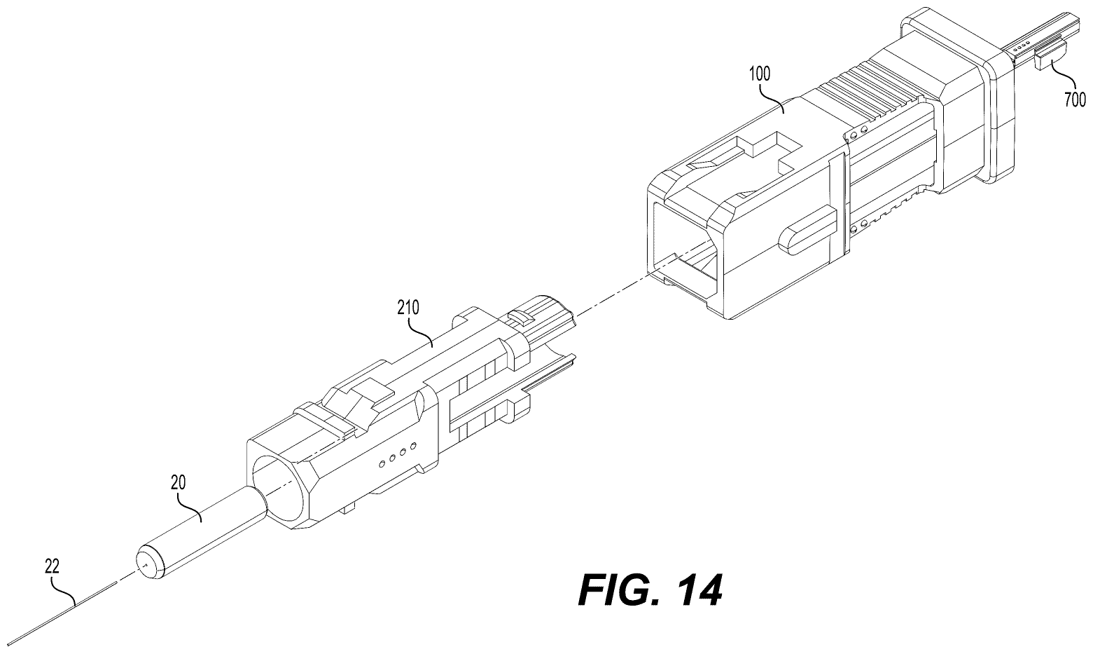

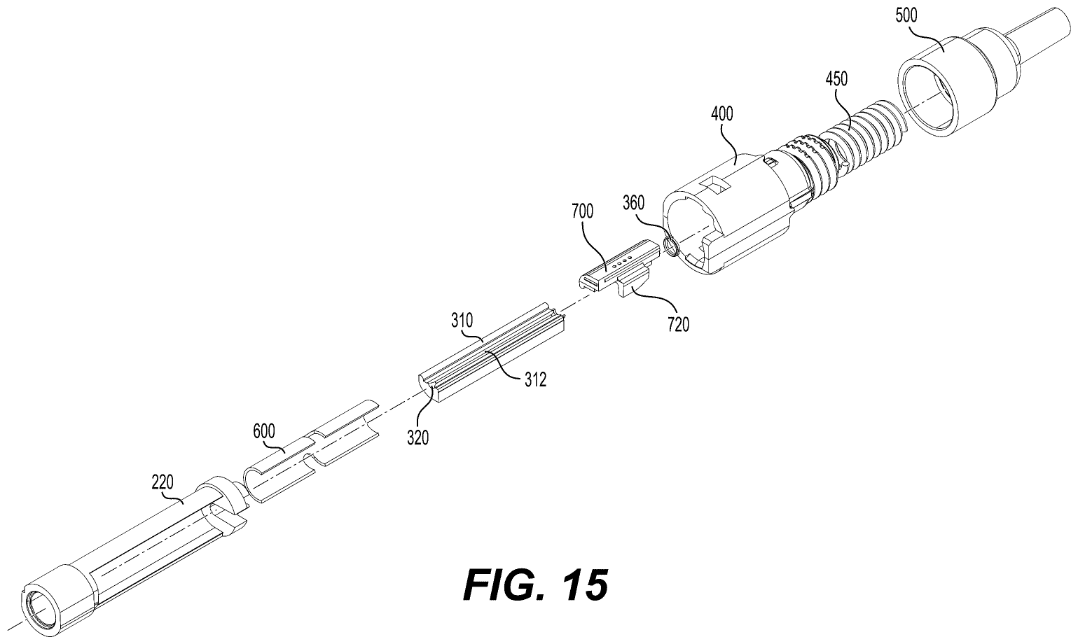

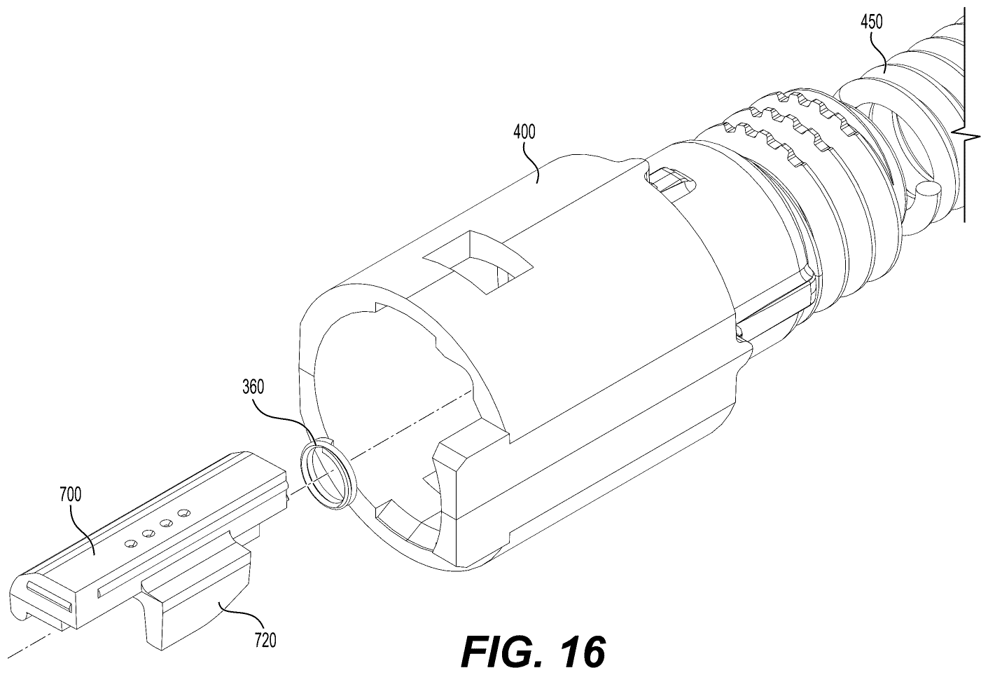

FIGS. 8-10 show exemplary exterior views of connector 10. FIGS. 11 and 12 show exemplary end views of connector 10. FIGS. 13-16 show various exploded views of connector 10. While the figures show connector 10, as an example, as a subscriber connector (SC) connector, it is noted that the principles of the disclosure are equally applicable to LC connectors and other types of connectors.

Although the illustrative embodiments of the present invention have been described herein with reference to the accompanying drawings, it is to be understood that the invention is not limited to those precise embodiments, and that various other changes and modifications may be effected therein by one skilled in the art without departing from the scope or spirit of the invention.

Various changes to the foregoing described and shown structures will now be evident to those skilled in the art. Accordingly, the particularly disclosed scope of the invention is set forth in the following claims.

1. A fiber optic connector structurally configured to mitigate against signal degradation when the connector is exposed to significant temperature fluctuations, comprising:
an outer housing portion;
an inner housing portion structurally configured to be coupled with the outer housing portion;
a fiber coupling portion having a first end and a second end and being structurally configured to optically couple an optical fiber and a fiber portion therein;
wherein the fiber coupling portion includes:
a fiber guide portion structurally configured to guide the optical fiber;
a fiber guide housing portion structurally configured to slidingly receive the fiber guide portion therein;
a fiber securing portion structurally configured to fixedly couple the fiber guide portion to the optical fiber; and
a fiber guide portion biasing portion structurally configured to bias the fiber guide portion toward the first end of the fiber coupling portion;
wherein the fiber guide portion is structurally configured to move axially within the fiber coupling portion between a first position and a second position;
wherein the fiber coupling portion is structurally configured to move axially within the inner housing portion;
wherein the fiber guide portion biasing portion is structurally configured to bias the fiber guide portion from the first position to the second position;
wherein the fiber guide portion comprises a fiber guide receiving portion;
wherein the fiber guide receiving portion is structurally configured to receive the optical fiber;
wherein the fiber guide receiving portion is structurally configured to align an end portion of the optical fiber with an end portion of the fiber portion;
wherein the fiber coupling portion includes a retaining portion that is structurally configured to secure the fiber guide portion in the first position against a force of the fiber guide portion biasing portion; and
wherein the retaining portion is structurally configured to be released to permit the fiber guide portion biasing portion to move the fiber guide portion from the first position to the second position such that the end portion of the optical fiber is urged into contact with the end portion of the fiber portion so as to maintain optical coupling between the optical fiber and the fiber portion and mitigate signal loss by biasingly urging against movement of the end portion of the optical fiber relative to the end portion of the fiber portion during operation of the connector and when the connector is exposed to temperature fluctuations between −40 degrees C. and 60 degrees C.

2. The connector of claim 1, wherein the fiber guide portion comprises a clamping portion structurally configured to bias the fiber securing portion to fixedly couple the fiber guide portion to the optical fiber.

3. The connector of claim 2, wherein the clamping portion is structurally configured as a c-shaped resilient clip.

4. The connector of claim 1, wherein the outer housing portion is an outer housing of an SC connector.

5. The connector of claim 1, wherein the fiber optic connector further comprises a cable receiving portion structurally configured to receive a portion of a fiber optic cable containing the optical fiber.

6. The connector of claim 1, wherein the fiber optic connector further comprises a boot portion structurally configured to engage the cable receiving portion.

7. The connector of claim 6, wherein the boot portion is structurally configured to form a seal with the fiber optic cable.

8. A fiber optic connector structurally configured to mitigate against signal degradation when the connector is exposed to temperature fluctuation, comprising:
a housing portion;
a fiber coupling portion having a first end and a second end and being structurally configured to optically couple an optical fiber and a fiber portion therein;
wherein the fiber coupling portion includes
a fiber guide portion structurally configured to guide the optical fiber;
a fiber guide housing portion structurally configured to slidingly receive the fiber guide portion therein; and
a fiber guide portion biasing portion structurally configured to bias the fiber guide portion toward the first end of the fiber coupling portion;
wherein the fiber guide portion is structurally configured to move axially in at least a portion of the fiber coupling portion between a first position and a second position;
wherein the fiber coupling portion is structurally configured to move axially within the housing portion;
wherein the fiber guide portion biasing portion is structurally configured to bias the fiber guide portion from the first position to the second position;
wherein the fiber guide portion comprises a fiber guide receiving portion;
wherein the fiber guide receiving portion is structurally configured to receive the optical fiber;
wherein the fiber guide receiving portion is structurally configured to align an end portion of the optical fiber with an end portion of the fiber portion; and
wherein the fiber guide portion is structurally configured to be released to permit the fiber guide portion biasing portion to move the fiber guide portion from the first position to the second position such that the end portion of the optical fiber is urged into contact with the end portion of the fiber portion so as to maintain optical coupling between the optical fiber and the fiber portion and mitigate against signal loss by biasingly urging against movement of the end portion of the optical fiber relative to the end portion of the fiber portion when the connector is exposed to temperature fluctuations between −40 degrees C. and 60 degrees C.

9. The connector of claim 8, wherein the housing portion comprises an outer housing portion and an inner housing portion structurally configured to be coupled with the outer housing portion.

10. The connector of claim 8, wherein the fiber coupling portion includes a retaining portion that is structurally configured to secure the fiber guide portion in the first position against a force of the fiber guide portion biasing portion.

11. The connector of claim 8, wherein the fiber optic connector further comprises a cable receiving portion structurally configured to receive a portion of a fiber optic cable containing the optical fiber.

12. The connector of claim 8, wherein the fiber coupling portion further comprises a fiber securing portion structurally configured to fixedly couple the fiber guide portion to the optical fiber.

13. The connector of claim 12, wherein the fiber guide portion comprises a clamping portion configured to bias the fiber securing portion to fixedly couple the fiber guide portion to the optical fiber.

14. The connector of claim 13, wherein the clamping portion comprises a c- shaped resilient clip.

15. A fiber optic connector structurally configured to mitigate against signal degradation even when the connector is exposed to significant temperature fluctuations, comprising:
a fiber coupling portion configured to optically couple an optical fiber and a fiber portion therein;
wherein the fiber coupling portion includes
a fiber guide portion configured to guide the optical fiber,
a fiber guide housing portion configured to slidingly receive the fiber guide portion therein, and
a fiber guide portion biasing portion configured to bias the fiber guide portion axially in at least a portion of the fiber coupling portion between a first position and a second position;
wherein the fiber guide portion is configured to align an end portion of the optical fiber with an end portion of the fiber portion; and
wherein the fiber guide portion is configured to permit the fiber guide portion biasing portion to bias the fiber guide portion from the first position toward the second position such that the end portion of the optical fiber is biasingly urged into contact with the end portion of the fiber portion so as to biasingly maintain optical coupling between the optical fiber and the fiber portion and mitigate against signal loss by biasingly preventing movement of the end portion of the optical fiber relative to the end portion of the fiber portion when the connector is exposed to temperature fluctuations between −40 degrees C. and 60 degrees C.

16. The connector of claim 15, wherein the cable connector further comprises a housing portion, and the fiber coupling portion is configured to move axially in at least a portion of the housing portion.

17. The connector of claim 15, wherein the fiber guide portion biasing portion is configured to bias the fiber guide portion toward an end of the fiber coupling portion.

18. The connector of claim 17, wherein the fiber guide portion biasing portion is configured to bias the fiber guide portion from the first position to the second position.

19. The connector of claim 15, wherein the fiber guide portion comprises a fiber guide receiving portion, and the fiber guide receiving portion is configured to receive the optical fiber.

20. The connector of claim 15, wherein the fiber coupling portion includes a retaining portion that is configured to secure the fiber guide portion in the first position against a force of the fiber guide portion biasing portion.

21. The connector of claim 15, wherein the fiber coupling portion further comprises a fiber securing portion that is configured to fixedly couple the fiber guide portion to the optical fiber.

22. The connector of claim 21, wherein the fiber guide portion comprises a clamping portion that is configured to bias the fiber securing portion to fixedly couple the fiber guide portion to the optical fiber.

23. The connector of claim 22, wherein the clamping portion comprises a c-shaped resilient clip.
